(19) United States
(12) Patent Application Publication
(10) Pub. No.: US 2005/0186044 A1
(43) Pub. Date: Aug. 25, 2005

(54) Process for machining

(76) Inventors: Parag L. Hegde, Greensburg, PA (US); Paul D. Prichard, Greensburg, PA (US); Gregory A. Hyatt, Barrington, IL (US)

Correspondence Address: John J. Prizzi;Kennametal Inc., P. O. Box 231, Latrobe, PA, 15650, US

(21) Appl. No.: 10/786,735

(22) Filed: Feb. 25, 2004

(51) Int. Cl. B23C 1/00

(52) U.S. Cl. 409/132

(57) ABSTRACT

The invention described is a method of milling bimetallic, aluminum-cast iron components with silicon nitride based ceramic cutting inserts.

### FIELD OF THE INVENTION

The present invention is directed to machining processes for machining bimetallic materials such as an aluminum or aluminum based alloy and a cast iron.

### BACKGROUND OF THE INVENTION

Cast iron engine blocks are commonly machined by silicon nitride based ceramics (e.g., KYON®-3500) indexable cutting inserts mounted in a cast iron style of milling cutter, i.e., having +10-20°, typically +10to −10, rake angles. (See: Kennametal Milling Catalog 0052 “Cast Iron Milling” (A01-090(8)G1, 2001, pp. 1-24). Silicon nitride based ceramic cutting inserts are not used to machine aluminum or aluminum alloys because of concerns with respect to aluminum buildup at the cutting edge of the cutting insert. In addition, silicon nitride inserts are most often used in dry milling of cast iron.

Bimetallic engine blocks are composed of an aluminum silicon alloy, for example, with cast iron (e.g., grey cast iron, ductile iron, or possibly compacted graphite iron) cylinder liners (for example, about 6 mm thick). The advantage of bimetallic engine blocks is that they reduce the weight of the engine thereby increasing gas mileage compared to a cast iron engine block. The cast iron liners also improve wear resistance compared to an aluminum alloy-only cylinder block, and allow use of higher compression ratios and/or higher ignition temperatures.

However, these bimetallic blocks are difficult to machine. About 90 to 95 percent of the surface area to be machined is aluminum alloy with the remainder being cast iron. Milling cutters designed for machining aluminum and aluminum alloys (i.e., having positive rake angles) are commonly used with PCD (polycrystalline diamond) cutting inserts. Aluminum buildup is prevented with the application of coolant or common metalworking fluids. PcBN (polycrystalline cubic boron nitride) or cemented carbides are also sometimes used. PCD inserts are preferred since they provide the best machining economics. However, the drawbacks of PCD milling of bimetallic engine blocks are significant. The PCD inserts are very expensive and typically have only one cutting edge per insert. In addition, in order to use PCD to its best advantage, a machine with a very high spindle speed may be required. PcBN inserts are also very expensive and typically don't provide the performance of diamond. Cemented carbide inserts are less expensive than PCD and PcBN but its performance is significantly less than either of the foregoing materials.

There has been a long felt need to provide a more efficient (i.e., less expensive) way of practically machining bimetallic engine blocks.

### SUMMARY OF THE INVENTION

Applicants have addressed this need with the following invention. In accordance with the present invention, it has been surprisingly discovered that ceramic silicon nitride based cutting inserts may be efficiently used to mill a bimetallic engine block. The cutting inserts may be comprised of silicon nitride or silicon aluminum oxynitride (i.e., sialon) along with other additives. The sialon may be a beta prime sialon (e.g., Si_{6-z}Al_{z}O_{z}N_{8-z}, where O<Z≦4.2) and/or an alpha prime sialon (e.g., MₓSi₁₂₋₍ₘ₊ₙ₎Alₘ₊ₙOₙN₁₆₋ₙ, where M may be Li, Ca, Y, Yb, Er, Tm, Sc, Lu or other lanthanides). Preferably, both alpha prime and beta prime sialons are present.

Preferably, the insert is an indexable insert having preferably at least 4, and more preferably 8, cutting edges. Preferably, the milling cutter is a cast iron style of milling cutter and preferably having at least four ceramic silicon nitride based indexable cutting inserts mounted thereon. More preferably, 24 to 60 silicon nitride based ceramic inserts are mounted on the milling cutter. Optionally, the milling cutter may also include a wiper insert which may be composed of a silicon nitride based ceramic or PCD or PcBN.

### DETAILED DESCRIPTION OF THE INVENTION

Applicants have discovered that bimetallic engine block surfaces may be cost efficiently milled using silicon nitride based ceramic cutting inserts. Silicon nitride based (at least 50 w/o of Si₃N₄, or one or more sialon phases) ceramic cutting inserts include both those having a beta silicon nitride phase and those having a sialon phase, such a beta prime sialon and/or alpha prime sialon. Examples of silicon nitride based ceramics having a beta silicon nitride phase include KYON®-3500 which is marketed by Kennametal Inc. of Latrobe, Pa. (see U.S. Pat. No. 5,525,134). KYON®-3500 is essentially all beta Si₃N₄ phase with an intergranular phase produced by sintering aids (magnesia and yttria). Examples of silicon nitride based ceramics having alpha prime and beta prime sialon phases include KYON®-1540 marketed by Kennametal Inc. (see U.S. Pat. No. 6,693,054). KYON®-1540 is ˜30 w/o alpha prime ˜70 w/o beta prime sialon with a grain bounding phase which, while primarily glassy, may have a crystalline phase(s) as well. Ytterbia is used as a sintering aid. The z value of the beta prime sialon is about 0.5 to 0.6 and the alpha prime sialon x value is about 0.35 to 0.37, and M is. ytterbium. KYON®-1310 may also be used. It is similar to KYON®-1540 but has a z value of about 0.35 to 0.38 and the x value is about 0.17 to 0.2. These cutting inserts may be used with or without a CVD and/or PVD coating thereon. An example of a CVD coated beta silicon nitride ceramic cutting insert is KYON®-3400 marketed by Kennametal Inc. It has a CVD coating containing alumina.

The cutting insert geometries that may be used in the present invention include any milling insert geometry which is effective. An example is the Fix-Perfect® indexable insert geometry marketed by Kennametal having 8 cutting edges. An example of another insert geometry contemplated is the LPE style of indexable inserts. The insert cutting edge may be honed and/or T-landed, but a honed edge is preferred.

The milling cutter used is preferably a style used to machine cast irons; that is, one that has low rake angles, e.g., +10 to −10° rake angle.

The advantages of the present invention are further indicated by the following examples which are intended to be purely illustrative of the present invention.

For a fly cut face milling test on a deck face (i.e., the face of the block that will mate with the cylinder head) of a GM PV8 bimetallic engine block, KYON®-3500 and KYON®-1540 cutting inserts were tested under the speeds and feeds shown in the tables with a 0.020 inch depth of cut. The length of each pass was about 22 inches. The insert geometry used in these tests was SPHX 1205 ZCTRGPK which a Fix-Perfect® style having 8 cutting edges and a 0.004 inch×20° T-landed edge preparation. This style of insert is shown and further described at page 16 of the aforementioned Kennametal 0052 Milling catalog. The face milling cutter used was a cast iron style, 10″ diameter Fix-Perfect® 20°/70° style cutter having a radial positive rake of 4° and an axial negative rake of 5° (Catalog No. 250C20RP70SP12C4WUFP, see the 0052 Milling Catalog, p. 10). Flood coolant was used in all tests. End of life criteria was as follows: 0.012 inch uniform flank wear, 0.016 maximum flank wear, and 0.016 nose wear. The most rapid form of wear observed was nose wear and when end of life criteria was reached during the test, it was due to nose wear in each case.

The remaining test conditions and the test results are shown in Tables I and II below:

TABLE I

| | | | Tool Life (# of passes) |
|---|---|---|---|
| Example # | Speed (sfm)* | Feed (ipt)* | KYON ®-1540 |
| 1 | 2400 | 0.008 | 2 |
| 2 | 3200 | 0.008 | 10+ |
| 3 | 4000 | 0.008 | 10+ |
| 4 | 4800 | 0.008 | 3 |
| 5 | 4800 | 0.004 | 20+ |
| 6 | 6400 | 0.004 | 8 |

*sfm = surface feet per minute/ipt = inch per tooth

TABLE II

| | | | Tool Life (# of passes) |
|---|---|---|---|
| Example # | Speed (sfm) | Feed (ipt) | KYON ®-3500 |
| 7 | 2400 | 0.008 | 7 |
| 8 | 3200 | 0.008 | 10+ |
| 9 | 4000 | 0.008 | 10+ |
| 10 | 4800 | 0.008 | 10+ |
| 11 | 4800 | 0.004 | 16 |
| 12 | 6400 | 0.004 | 14 |

The plus (+) signs in the tables indicate tests in which no failure criteria had been met but the test was stopped in order to save time. Examination of inserts after the tests showed that there was no aluminum built up edge on the used inserts. No excessive smearing of aluminum on the inserts was observed. Examination of the machined surface on the engine block indicated some breakout on the cast iron liners. It is believed that this issue may be resolved by using a honed cutting edge rather than a T-land on this particular workpiece.

These examples clearly demonstrate the surprisingly good performance of beta silicon nitride (KYON®-3500) and alpha prime-beta prime sialon (KYON®-1540) in face milling a bimetallic aluminum alloy-cast iron engine block surface. It is theorized that the presence of the cast iron in the material minimizes aluminum buildup on the cutting edge, surprisingly allowing the successful use of silicon nitride based ceramics on these high aluminum content materials.

All documents, including catalogs, patents and patent applications referred to herein are hereby incorporated by reference in their entireties.

Other embodiments of the invention will be apparent to those skilled in the art from the practice of the invention disclosed herein or from a consideration of this specification. It is intended that the specification and examples be considered as exemplary only, with the true scope and spirit of the invention being indicated by the following claims.

1. A method of machining comprising the steps of:
milling a surface of a bimetallic material having an aluminum surface and a cast iron surface with a milling cutter having mounted thereon silicon nitride based ceramic cutting inserts.

2. The method according to claim 1 further comprising controlling the speed of the milling to between 2,000 and 10,000 surface feet per minute.

3. The method according to claim 1 further comprising controlling the speed of milling to between 2400 and 6400 sfm.

4. The method according to claim 1 wherein the silicon nitride based ceramic cutting inserts have a Si₃N₄ phase.

5. The method according to claim 1 wherein the silicon nitride based insert has a sialon phase.

6. The method according to claim 1 wherein the silicon nitride based ceramic insert has a beta prime sialon phase.

7. The method according to claim 1 wherein the silicon nitride based ceramic insert also has an alpha prime sialon phase.

8. The method of machining according to claim 1 further comprising controlling the speed of milling to 3,200 surface feet per minute or more.

9. The method according to claim 1 further comprising applying coolant during the milling step.

10. A method of machining the surface of a bimetallic engine block comprising an aluminum alloy having cast iron cylinder liners therein, wherein the method comprises the steps of:
milling said surface with a milling cutter having silicon nitride based ceramic cutting inserts mounted thereon.

11. The method according to claim 10 further comprising controlling the speed of the milling to between 2,000 and 10,000 surface feet per minute.

12. The method according to claim 10 further comprising controlling the speed of milling to between 2400 and 6400 sfm.

13. The method according to claim 10 wherein the silicon nitride based ceramic cutting inserts have a Si₃N₄ phase.

14. The method according to claim 10 wherein the silicon nitride based insert has a sialon phase.

15. The method according to claim 10 wherein the silicon nitride based ceramic insert has a beta prime sialon phase.

16. The method according to claim 10 wherein the silicon nitride based ceramic insert also has an alpha prime sialon phase.

17. The method of machining according to claim 10 further comprising controlling the speed of milling to 3,200 surface feet per minute or more.

18. The method according to claim 10 further comprising applying coolant during the milling step.
